(19) United States
(12) Patent Application Publication
(10) Pub. No.: US 2003/0137539 A1
(43) Pub. Date: Jul. 24, 2003

(54) Method of styling a user interface and device with adaptive user interface

(76) Inventor: Walter Dees, Eindhoven (NL)

Correspondence Address: U.S. Philips Corporation, 580 White Plains Road, Tarrytown, NY, 10591, US

(21) Appl. No.: 10/262,384

(22) Filed: Oct. 1, 2002

(30) Foreign Application Priority Data
Oct. 4, 2001 (EP) 01203753.7

(51) Int. Cl. G09G 5/00

(52) U.S. Cl. 345/762

(57) ABSTRACT

A method of styling a user interface for a device (400), and a device (400) having an adaptive user interface. Style information for the user interface is received. This style information is associated with nodes in a hierarchical tree, each node in the tree corresponding to a device characteristic. Each node corresponds to a more specific device characteristic than its parent node. A best matching node in the hierarchical tree is chosen, and style information for the chosen node and all parents of the chosen node is collected. The collected style information is then applied to the user interface.

The invention relates to a method of styling a user interface for a device. The invention further relates to a device with an adaptive user interface and to a computer program product.

The eXtensible Markup Language (XML) can be used for a great variety of purposes. One of these purposes is the definition of user interfaces. An abstract definition of a user interface with elements such as buttons, sliders, checkboxes, radio buttons and so on can be provided using an XML document, preferably adhering to some Document Type Definition (DTD) or Schema. This way, the user interface can easily be generated on different client devices, i.e. devices that generate and present the user interface to a user, by parsing the XML document and rendering the indicated user interface elements.

A client device wishing to render the user interface provided in the user interface definition document typically needs additional information regarding the look and feel, or more generally the style of the user interface elements. Typically this information is provided in so-called style sheets. Using a language such as CSS or DSSSL, style properties such as the font or the color of a button or the position of a checkbox on the screen can easily be defined.

To provide flexibility in the style definitions, a modular approach can be used. Rather than providing one single style sheet document, the style information is separated into various documents. This way generic style definitions such as the font to be used can be provided in a generic style sheet document, and platform-specific style definitions such as the positioning of the user interface elements in a window on the screen can be provided in specific style sheet documents.

The various style sheet documents need to be provided together, so that the client device can use all the style definitions that are applicable to that particular platform. One solution is to provide in the user interface definition a list of the style sheets, together with an indication of their intended use. For example, a generic style sheet together with a style sheet for printing, one for on-screen display and one for a speech synthesizer.

Another, more flexible solution involves the inclusion by reference of one style sheet document into another. In CSS, for instance, this is done using the “@import” statement. A style sheet with specific style information can use the “@import” statement to refer to another, typically a more generic style sheet. This way multiple different specific style sheet documents can all benefit from the definitions in the more generic style sheet.

Using this mechanism a provider can make available different specific style sheets for different platforms together with one or more generic style sheets. The specific style sheets then include the generic style sheet(s) by reference. A client device on a particular platform then downloads the user interface definition and the specific style sheet for that particular platform, as well as any generic style sheets referenced in the specific style sheet. The client device can then generate and render the user interface.

A problem inherent in this approach is that the client device needs a specific style sheet for its particular platform. This implies that the provider needs to make available a specific style sheet for every possible platform, which is next to impossible. The client device could of course also directly download the generic style sheet, but then it misses out on any platform-specific style information.

One cause of this problem lies in the fact that the style information is essentially organized in an arbitrary fashion. There is no semantic information that would link e.g. style information for a 640×480-pixel display with style information for a landscape-oriented display. The client device would have to process all style information to see if there was any style information that could be relevant to its specific capabilities. This is not very effective.

It is an object of the invention to provide a method according to the preamble, which allows for more effective processing of style information.

This object is achieved according to the invention in a method comprising obtaining style information for the user interface, the style information being associated with nodes in a hierarchical tree, each node in the tree corresponding to a device characteristic, whereby a child node corresponds to a more specific device characteristic than its parent node, choosing a node in the hierarchical tree, collecting style information for the chosen node and all parents of the chosen node, and applying the collected style information to the user interface.

Using a hierarchical tree structure has the advantage that it is easier to automatically process the style information. A simple hierarchical organization of device characteristics could begin with “graphical display”, subdivided into “portrait-oriented display” and “landscape-oriented display”. The category “landscape-oriented display” could be subdivided further into e.g. “4:3 ratio display” and “16:9 ratio display”. And “4:3 ratio display” could in turn be subdivided into specific resolutions such as 640×480 or 800×600.

It is now possible to collect style information based on device characteristics by choosing nodes from the tree that match a given device characteristic. Also, it is possible to collect relevant style information that does not directly match the characteristics of a given device by collecting style information associated with the parents (which includes the direct parent node, but also the grandparent nodes, the great-grandparent node and so on) of the chosen node.

For example, a device with a 640×480 pixel display would not only collect style information at the node for “640×480 pixel display” in the tree example hierarchy given above, but also at the nodes for “4:3 ratio display”, “landscape-oriented display” and “graphical display”, since all these nodes represent device characteristics that are matched by a device with a 640×480 pixel display. These nodes are parents to the node “640×480 pixel display”, and so can immediately be identified so their style information can be accessed.

In an embodiment the chosen node corresponds to a device characteristic that matches the device. The chosen node can serve as a reference point for collecting style information. Since the device characteristics are organized according to a hierarchical tree, it follows that all parent nodes of the chosen node must also correspond to device characteristics that match the device. This style information should then also be collected.

In a variant of this embodiment the chosen node is the lowest node in the tree corresponding to a device characteristic that matches the device. This way, it is ensured that the most relevant style information for the device is collected.

In a further embodiment style information at a first level of the tree is made available in a first style sheet document, style information at a second level of the tree, lower than the first level, is made available in a second style sheet document, and a link is provided in the first style sheet document to the second style sheet document.

In this fashion there is always a single style sheet that serves as a starting point, regardless of any specific style sheets that may also be available. The link from the first to the second style sheet allows a client device to access the more specific style information. Multiple links to multiple second-level style sheets can also be provided, giving a client device a choice on which to use based on its characteristics.

This embodiment further advantageously makes reuse of style information easier. Since the style information must be provided in accordance with the hierarchical tree, more generic style information will be associated with nodes that lie higher in the tree than nodes associated with more specific style information. The more generic style information can then be provided in the first, and the more specific style information in the second style sheet document. This allows the generic style information to be reused.

In a variant of this embodiment the link to the second style sheet document is provided through a link element within the scope of a language element representing a parent of a node associated with style information in the second style sheet document. XML is the de facto standard for marking up information, so using XML here is preferred.

By providing the link in this fashion, cascading of style information becomes possible on a basis of individual device characteristics, rather than on a basis of one specific style sheet document for every device, as is the case with prior art systems such as CSS, XSL or DSSSL. This gives much greater flexibility.

In a further embodiment the method further comprises determining a shortest path in the tree from the top node to the chosen node, and collecting the style information associated with the nodes on the shortest path. This embodiment allows selective collecting of style information, since now only the nodes on the shortest path are involved. Other nodes can be skipped altogether. This reduces the amount of style information that is to be processed.

Style information may need to be merged, for example through inheritance or cascading. By skipping nodes outside the shortest path, the amount of irrelevant style information to be considered is reduced. Also, if the style information is made available in plural style sheet documents, then this embodiment reduces the number of style sheet documents that needs to be accessed to only those documents that comprise style information for nodes in the shortest path.

In a variant of this embodiment the method further comprises collecting the style information starting with the top node. This way, there is always a known entry point in the tree, and it is not necessary to know where exactly the chosen node is located in the tree.

In a further embodiment the collected style information is transmitted to the device before applying the collected style information to the user interface. This makes it possible to collect the style information in a server, rather than in the (client) device on which the user interface that is to be styled resides.

Client devices may be restricted in their processing capabilities, for example because they are battery-driven or have only limited memory, CPU processing power or available bandwidth for the transmission of style information. It is then advantageous to collect the style information on a server with higher processing capabilities, so that only the result needs to be transmitted to the client. The client then only needs to apply the collected style information to its user interface, which requires less processing power. Bandwidth is also saved, because only the directly relevant style information is now transmitted to the client device.

These and other aspects of the invention will be apparent from and elucidated with reference to the embodiments shown in the drawings, in which:

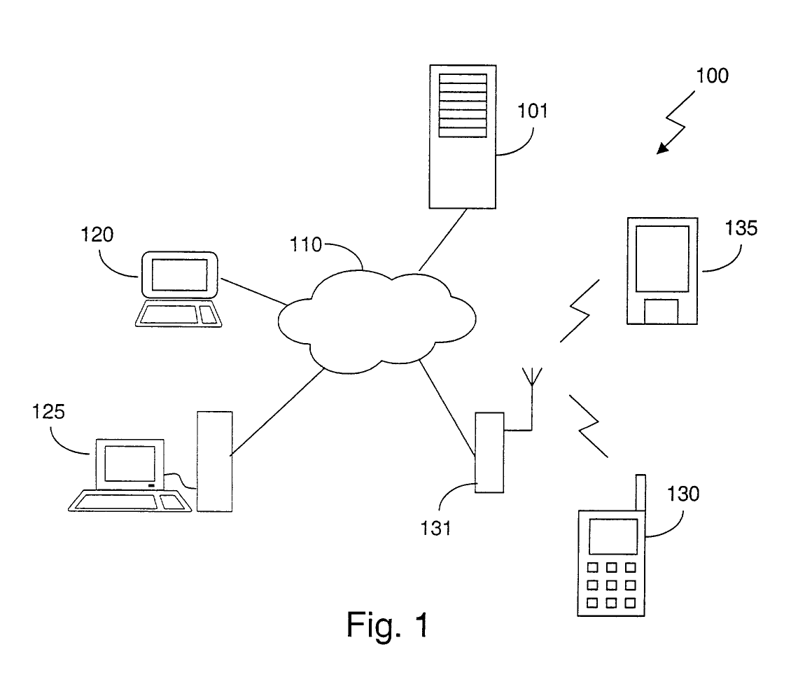

FIG. 1 schematically shows a system comprising a server and several clients;

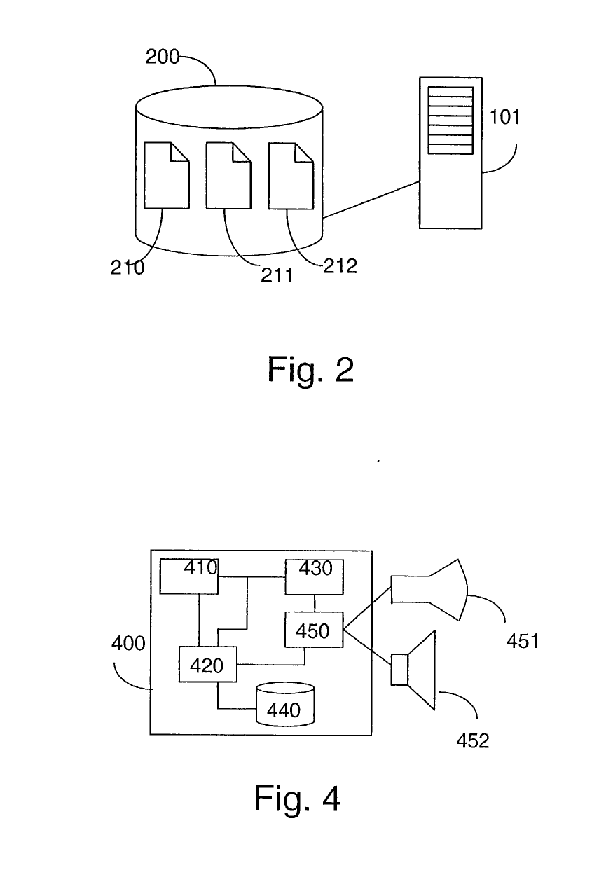

FIG. 2 schematically shows the server in more detail;

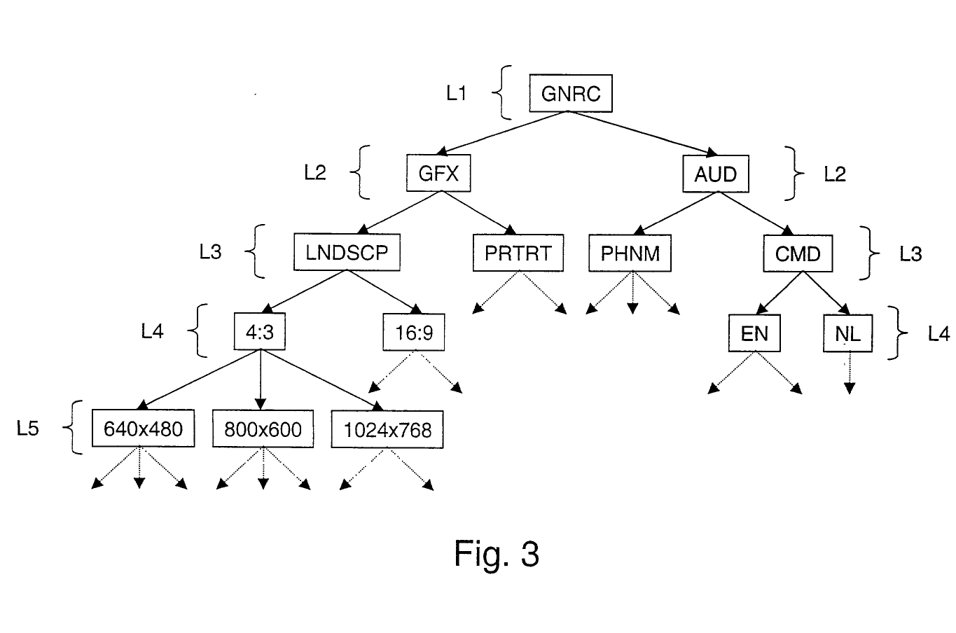

FIG. 3 schematically shows a hierarchically organized grouping of style information; and

FIG. 4 schematically shows a client device in more detail.

Throughout the Figures, same reference numerals indicate similar or corresponding features. Some of the features indicated in the drawings are typically implemented in software, and as such represent software entities, such as software modules or objects.

FIG. 1 schematically shows a system 100 according to the invention. The system 100 comprises a server 101 connected to a network 110 such as the Internet or a Local Area Network (LAN). Also connected to the network 110 are various clients: a laptop computer 120, a desktop computer 125, a mobile phone 130 and a handheld computer 135.

The computers 120, 125 have a wired connection to the network 110, e.g. through an Ethernet, IEEE 1394 or dial-up connection. The mobile phone 130 and the handheld computer 135 have a wireless connection to the network 110 e.g. via Bluetooth beacon 131, or using a GSM, DECT, GPRS or UMTS connection to connect to a base station connected to the network 110. Other devices, such as a digital television, DVD player/recorder or other CE device may also be connected to the network 110.

FIG. 2 schematically shows the server 101 in more detail. The server 101 comprises a storage medium 200 on which information available for downloading can be stored. In accordance with the invention, the storage 200 comprises a user interface definition document 210, a first style sheet document 211 and a second style sheet document 212.

The user interface definition document 210 can be downloaded by one or more of the clients 120, 125, 130, 135 and can then be used to generate a user interface on the clients 120, 125, 130, 135. This user interface could serve a variety of purposes. For instance, the user interface could be used to control a process running on the server 101 or to control another device connected to the server 101. The user interface could also be intended for an operation on the client 120, 125, 130, 135 itself.

Various ways are known in the art to provide a user interface definition. Some examples are: the User Interface Markup Language (UIML), as described on the Internet at http://www.uiml.org, or the eXtensible User Interface Language (XUL), a programmer's reference of which is available on the Internet at http://www.mozilla.org/xpfe/xulref/. The well-known HyperText Markup Language HTML also provides (limited) ways to provide a user interface definition, in particular when providing fill-in forms.

It is common to provide style information for abstract elements, including user interface elements, by specifying one or more so-called properties for those elements. The color of a graphical element (a “widget”) is a property, as is its font, the X- and Y-coordinates on the screen, and so on. The user interface as a whole also has properties, e.g. its layout, default fonts, a background color or image, etcetera. A style sheet document then provides values for one or more of these properties.

Properties can be specified for all user interface elements of a particular type. Additionally, properties can be specified for a certain class of elements, for example all buttons used in confirmation dialogues or all text shown in menus. Properties can also be specified for individual elements. Typically this is done by assigning the individual element a unique identifier through the ID attribute in XML and specifying the property for an element having a particular ID.

Values for properties can cascade. For example, the font property for the user interface as a whole can be given as “Times New Roman”. Text on any buttons for which no font property value is provided is then displayed in Times New Roman. However, the font property for a particular button could be set to “Garamond”, and the text on that particular button would then be in Garamond rather than Times New Roman.

FIG. 3 schematically illustrates a possible hierarchical organization of the style properties that will be used in the examples below. The highest point of the hierarchy, level L1, provides the most generic style information, although it is rare for style information to be applicable for all types of user interfaces. Level L1 therefore serves mainly as an entry point into the hierarchical tree shown in FIG. 3.

One level lower, at level L2 in the hierarchy, a first distinction can be made between graphical style information GFX and audio style information AUD. At this level, graphical style information GFX could comprise properties such as colors or fonts to be used.

The graphical style information GFX can be provided more specifically using a distinction in orientation, e.g. portrait PRTRT or landscape LNDSCP at level L3. At this level L3, the general relative arrangements of user interface elements can be defined.

A lower level L4 in the hierarchy further refines the distinction is an aspect ratio such as 4:3 or 16:9. At this level L4, style properties such as the relative alignment of user interface elements, minimum and maximum sizes of elements, width and height of individual user interface elements expressed in percentages can be defined.

An even further refinement would be a specific definition for the screen size to be used: 640×480 pixels, 800×600, 1024×768 and so on. At this level L5, properties such as margins, font size, background illustrations and width and height of individual user interface elements expressed in pixels can be defined.

In the audio style information AUD a distinction can be made in level L3 between various speech recognition input types available, such as command-based recognition CMD and phoneme-based recognition PHNM. A further distinction, leading to level L4, could be the vocabulary to be used, e.g. the English language EN or Dutch language NL.

Yet further levels in the hierarchy, as well as other levels next to the ones shown in FIG. 3 can also be conceived. Different client devices may have different user interface types, or handle user interface elements different. For example, on the desktop personal computer 125, a menu bar is typically shown at the top of the screen, whereas on the handheld computer 135 the menu bar is typically only shown upon user request (e.g. by pressing a ‘menu’ button). The mobile phone 130 may not be capable of displaying menus with submenus with options, but rather displays a list with the options from which the user can choose.

FIG. 4 schematically shows a client device 400 in more detail. As explained above, the client device 400 can be for instance the laptop computer 120, the desktop computer 125, the mobile phone 130, the handheld computer 135 or another device such as a television, video or DVD recorder, and so on.

The client device 400 comprises a networking module 410 which obtains the user interface definition document 210 from the server 101, via the network 110. The document 210 is then fed to a user interface module 420, which processes the document 210 in order to generate a user interface. A rendering module 450 then presents the generated user interface to a user of the client device 400 using output means such as a display 452 or a speaker 451. Style information is applied to this user interface, as will become apparent below.

An input module 430 receives input from the user during his interaction with the user interface. The input can be fed back to the user interface module 420, which updates the user interface. Some of the input may also be sent back to the server 101 using the networking module 410. Other kinds of input by the user can directly be handled by the rendering module 450. Such an arrangement is generally known in the art and will not be elaborated upon further.

In accordance with the invention, the user interface module 420 processes the document 210 and finds that the document 210 contains a reference to the first style sheet document 211. The user interface module 420 then activates the networking module 410 to cause it to download the first style sheet document 211 from the server 101. Having downloaded the document 211, the networking module 410 feeds the document 211 to the user interface module 420. The user interface module 420 then uses the style information contained in the document 211 in generating the user interface.

The first style sheet document 211 may also already be present on local storage in the device 400, so that it can be obtained by simply reading it from the local storage. For instance, the networking module 410 may have downloaded the style sheet document together with the document 210, or the first style sheet document 211 may have been supplied on a record carrier.

The first style sheet document 211 can comprise style information in any language suitable for marking up style information, such as CSS or DSSSL. It is also possible to use XML to mark up style information. An illustrative embodiment of the first style sheet document 211 as an XML document is shown below.

| | |
|---|---|
| (1) | <?xml version=“1.0”?> |
| (2) | <uisl level=“1”> |

| | |
|---|---|
| (3) | <gfx> |

| | |
|---|---|
| (4) | <landscape> |

| | |
|---|---|
| (5) | <layout> |

| | |
|---|---|
| (6) | <container>paneltree</container> |

| | |
|---|---|
| (7) | </layout> |
| (8) | <level2 stylesheet=“stylesheet-landscape.uisl”/> |

| | |
|---|---|
| (9) | </landscape> |
| (10) | <portrait> |

| | |
|---|---|
| (11) | <layout> |

| | |
|---|---|
| (12) | <container>panelsplit</container> |

| | |
|---|---|
| (13) | </layout> |
| (14) | <level2 stylesheet=“stylesheet-portrait.uisl”/> |

| | |
|---|---|
| (15) | </portrait> |

| | |
|---|---|
| (16) | </gfx> |

| | |
|---|---|
| (17) | </uisl> |

The above XML document 211 is well-formed. An example XML DTD that makes the above document 211 also valid in the XML sense is given below.

| (1) | <?xml version=“1.0” | |
|---|---|---|
| | encoding=“UTF-8”?> | |
| (2) | <!ENTITY % num “CDATA”> | |
| (3) | <!ENTITY % coreattrs | |
| (4) | | id CDATA # IMPLIED |
| (5) | | class CDATA #IMPLIED> |
| (6) | <!ENTITY % elements | |
| (7) | (container\|list\|range\|entry\|button\| | |
| | progress\|text\|image\|all)*> | |
| (8) | <!ELEMENT uisl (gfx\|audio) > | |
| (9) | <!ATTLIST uisl | |
| (10) | | level % num; #REQUIRED> |
| (11) | <!ELEMENT gfx (general\|portrait\|landscape)> | |
| (12) | <!ELEMENT general (bgcolor?, font?)> | |
| (13) | <!ELEMENT bgcolor %elements;> | |
| (14) | <!ELEMENT font %elements;> | |
| (15) | <!ELEMENT portrait (layout?, | |
| | orientation?, level2?)> | |
| (16) | <!ELEMENT landscape (layout?, | |
| | orientation?, level2?)> | |
| (17) | <!ELEMENT layout (container)*> | |
| (18) | <!ELEMENT orientation %elements;> | |
| (19) | <!ELEMENT audio (generalaudio\| | |
| | commandbased\|phonemebased)> | |
| (20) | <!ELEMENT generalaudio (focussound? | |
| | actionsound?)> | |
| (21) | <!ELEMENT focussound %elements;> | |
| (22) | <!ELEMENT actionsound %elements;> | |
| (23) | <!ELEMENT commandbased (level2)> | |
| (24) | <!ELEMENT phonemebased (level2)> | |
| (25) | <!ELEMENT level2 EMPTY> | |
| (26) | <!ATTLIST level2 | |
| (27) | | stylesheet CDATA #REQUIRED |
| (28) | | stylesheet-type CDATA #IMPLIED> |

| | |
|---|---|
| (29) | <!ELEMENT container (#PCDATA)> |
| (30) | <!ATTLIST container %coreattrs;> |
| (31) | <!ELEMENT list (#PCDATA)> |
| (32) | <!ATTLIST list coreattrs;> |
| (33) | <!ELEMENT range (#PCDATA)> |
| (34) | <!ATTLIST range %coreattrs;> |
| (35) | <!ELEMENT entry (#PCDATA)> |
| (36) | <!ATTLIST entry %coreattrs;> |
| (37) | <!ELEMENT button (#PCDATA)> |
| (38) | <!ATTLIST button %coreattrs;> |
| (39) | <!ELEMENT progress (#PCDATA)> |
| (40) | <!ATTLIST progress %coreattrs;> |
| (41) | <!ELEMENT text (#PCDATA)> |
| (42) | <!ATTLIST text %coreattrs;> |
| (43) | <!ELEMENT image (#PCDATA)> |
| (44) | <!ATTLIST image %coreattrs;> |
| (45) | <!ELEMENT all (#PCDATA)> |
| (46) | <!ATTLIST all %coreattrs;> |

This DTD may be installed in the client device 400 or be downloaded when desired using the networking module 410. To be valid, the style sheet document 211 needs a <!DOCTYPE> declaration referring to this DTD, and of course should validate against the DTD. An interpretation of the various elements and attributes used in the style sheet document 211 and this DTD is given at the end of this specification. It is observed here that the element definitions on lines 8, 11, 19, 23 and 24 refer to device characteristics, whereas element definitions on lines 12-18, 20-22 and 29-46 refer to style properties. See the table at the end of this specification for a detailed explanation of the XML elements used and their preferred interpretation.

Assume for the sake of example that the user interface is to be presented on the display 452, which has a 640×480 pixel resolution. This device characteristic, as well as other characteristics, can be stored as a list of device characteristics e.g. in memory 440, so that the user interface module 420 can consult this list for selecting the appropriate style information. This list, or a portion thereof, could also be downloaded by the networking module 410. This list can be seen as a device characteristics profile of the client device 400.

In addition to device characteristics, the list may also contain user preferences for one or more users of the device 400. Such user preferences could set style properties such as preferred font size or color schemes. A user with bad eyesight might want to specify large font sizes, overriding small font sizes as indicated in the style sheet documents, for example. When using the device 400, the user may be prompted to identify himself, so that only his own user preferences are used. This allows one user to specify for instance large fonts and another to specify small fonts to be used on the same display.

To style the user interface, the user interface module 420 starts at level L1 of the hierarchical tree, which corresponds to the UISL element on line 2. There is one child element of the UISL element, namely the GFX element, which corresponds to level L2. Since this element represents graphical style information, and a characteristic of the device 400 is that it has graphical display 452, the user interface module 420 collects the style information comprised in the GFX element.

The GFX element comprises child elements LANDSCAPE and PORTRAIT, corresponding to nodes LNDSCP and PRTRT at level L3 in the tree of FIG. 3. A device characteristic of device 400 is that its display has a landscape orientation, and so the user interface module 420 selects the child element LANDSCAPE and collects the style information comprised therein (lines 4-9). The user interface module 420 then arranges the user interface elements as a panel tree.

The user interface module 420 encounters on line 8 in the first style sheet document 211 a link to the second, more specific style sheet document 212 named “stylesheet-landscape.uisl”, realized through an XML element called <level2>.

The second style sheet document 212 contains more specific style information for devices that employ a landscape-oriented visual user interface. Since this is in line with the characteristics of the device 400, the user interface module 420 now activates the networking module 410 to download the second style sheet document 212 from the server 101. Preferably the link to style sheet document “stylesheet-portrait.uisl” in line 14 is ignored, since it is does not match device characteristics of the device 400. Ignoring this irrelevant style sheet document saves bandwidth and/or processing time.

An illustrative embodiment of the second style sheet document 212 is given below.

| (1) | <?xml version=“1.0”?> | |
|---|---|---|
| (2) | <uisl level=“2”> | |
| (3) | | <4×3> |

| | |
|---|---|
| (4) | <halign> |

| | |
|---|---|
| (5) | <all class=“settings”>center</all> |
| (6) | <all class=“effects”>left</all> |

| | |
|---|---|
| (7) | </halign> |
| (8) | <level3 stylesheet=“stylesheet-landscape-4×3.uisl”/> |

| | |
|---|---|
| (9) | </4×3> |

| | |
|---|---|
| (10) | </uisl> |

The second style sheet document 212 is well-formed. An example DTD that makes the document 212 also valid in the XML sense is given below.

| (1) | <?xml version=“1.0” encoding=“UTF-8”?> | |
|---|---|---|
| (2) | <!ENTITY % num “CDATA”> | |
| (3) | <!ENTITY % coreattrs | |
| (4) | | “id CDATA #IMPLIED |
| (5) | | class CDATA #IMPLIED”> |
| (6) | <!ENTITY % elements | |
| (7) | | “(container\|list\|range\|entry\|button\|progress\| |
| | text\|image\|all)*”> | |
| (8) | <!ELEMENT uisi (4×3?, 16×9?, otherratio?)> | |
| (9) | <!ATTLIST uisl | |
| (10) | | level %num; #REQUIRED> |
| (11) | <!ELEMENT 4×3 (minwidth?, minheight?, maxwidth?, | |
| | maxheight?, halign?, valign?, alwaysvisible?, | |
| | alwaystogether?, level3?)> | |
| (12) | <!ELEMENT 16×9 (minwidth?, minheight?, maxwidth?, | |
| | maxheight?, halign?, valign?, alwaysvisible?, | |
| | alwaystogether?, level3?)> | |
| (13) | <!ELEMENT otherratio (minwidth?, minheight?, maxwidth?, | |
| | maxheight?, halign?, valign?, alwaysvisible?, | |
| | alwaystogether?, level3?)> | |
| (14) | <!ATTLIST otherratio | |
| (15) | | longside %num; #REQUIRED |
| (16) | | shortside %num; #REQUIRED> |
| (17) | <!ELEMENT minwidth (container)*> | |
| (18) | <!ELEMENT minheight (container)*> | |
| (19) | <!ELEMENT maxwidth (container)*> | |
| (20) | <!ELEMENT maxheight (container)*> | |
| (21) | <!ELEMENT halign %elements;> | |
| (22) | <!ELEMENT valign %elements;> | |
| (23) | <!ELEMENT alwaysvisible %elements;> | |
| (24) | <!ELEMENT alwaystogether (container)*> | |
| (25) | <!ELEMENT level3 EMPTY> | |
| (26) | <!ATTLIST level3 | |
| (27) | | stylesheet CDATA #REQUIRED |
| (28) | | stylesheet-type CDATA #IMPLIED> |

| | |
|---|---|
| (29) | <!ELEMENT container (#PCDATA)> |
| (30) | <!ATTLIST container %coreattrs;> |
| (31) | <!ELEMENT list (#PCDATA) > |
| (32) | <!ATTLIST list %coreattrs;> |
| (33) | <!ELEMENT range (#PCDATA)> |
| (34) | <!ATTLIST range %coreattrs;> |
| (35) | <!ELEMENT entry (#PCDATA)> |
| (36) | <!ATTLIST entry coreattrs;> |
| (37) | <!ELEMENT button (#PCDATA)> |
| (38) | <!ATTLIST button coreattrs;> |
| (39) | <!ELEMENT progress (#PCDATA)> |
| (40) | <!ATTLIST progress coreattrs;> |
| (41) | <!ELEMENT text (#PCDATA)> |
| (42) | <!ATTLIST text coreattrs;> |
| (43) | <!ELEMENT image (#PCDATA)> |
| (44) | <!ATTLIST image coreattrs;> |
| (45) | <!ELEMENT all (#PCDATA)> |
| (46) | <!ATTLIST all coreattrs;> |

An interpretation of the various elements and attributes used in the style sheet document 211 and this DTD is given at the end of this specification.

The second style sheet document 212 provides more specific style information for a graphical display with a landscape orientation, by providing style information for a graphical display with a 4:3 aspect ratio. The user interface module 420 parses the second style sheet document 212 and determines that more specific style information is available for displays with resolutions in a ratio of 4:3. Since the display 452 has a 640×480 resolution, which corresponds to a ratio of 4:3, the user interface module 420 collects this information.

The <4×3> element also contains a link to a lower-level style sheet document, realized through an XML element called <level3>. The user interface module 420 could now activate the networking module 410 to download this lower-level style sheet document and apply the more specific style information contained therein. This mechanism can of course be applied for even lower levels as well. At some point, the lower-level style sheet can be specific to one particular client device. It may be desirable to let the vendor or manufacturer of that particular client device define the specific lower-level style sheet.

An illustrative embodiment of such a third style sheet document with more specific style information for a graphical display with a 4:3 aspect ratio is given below.

| (1) | <?xml version=“1.0”?> | |
|---|---|---|
| (2) | <uisl level=“2”> | |
| (3) | | <640×480> |

| | |
|---|---|
| (4) | <bgpicture> |

| | |
|---|---|
| (5) | <container id=“main”>dinosaur_{—} |
| | small.jpg</container> |

| | |
|---|---|
| (6) | </bgpicture> |
| (7) | <maxwidth> |

| | |
|---|---|
| (8) | <container id=“settings”>500</container> |

| | |
|---|---|
| (9) | </maxwidth> |
| (10) | <maxheight> |

| | |
|---|---|
| (11) | <container id=“settings”>250</container> |

| | |
|---|---|
| (12) | </maxheight> |
| (13) | <margintop> |

| | |
|---|---|
| (14) | <container id=“settings”>100</container> |

| | |
|---|---|
| (15) | </margintop> |
| (16) | <marginleft> |

| | |
|---|---|
| (17) | <container id=“settings”>50</container> |

| | |
|---|---|
| (18) | </marginleft> |
| (19) | <fontsize> |

| | |
|---|---|
| (20) | <all>medium</all> |

| | |
|---|---|
| (21) | </fontsize> |

| | |
|---|---|
| (22) | </640×480> |
| (23) | <1024×768> |

| | |
|---|---|
| (24) | <bgpicture> |

| | |
|---|---|
| (25) | <container id=“main”>dinosaur_{—} |
| | big.jpg</container> |

| | |
|---|---|
| (26) | </bgpicture> |

| | |
|---|---|
| (27) | </1024×768> |

| | |
|---|---|
| (28) | </uisl> |

This third style sheet document provides specific style sheet information for graphical devices with a 640×480 or with a 1024×768 pixel resolution display. This style sheet document could also be made valid by defining an appropriate DTD.

In these embodiment the style properties for user interface elements are defined as follows. A style property is given as an XML element, which contains a list of user interface element(s) to which the style property applies. These user interface elements are also given as XML elements. They contain the value for the style property as it applies to that user interface element. User interface elements can be addressed by type, ID or class.

In the above description, the user interface module 420 started out with the <uisl> element in the first style sheet document 211 and then accessed more and more specific information contained in second and further style sheet documents. In effect, at every level the user interface module 420 would select a child element of a previously selected element that had a device characteristic that matches the device.

The user interface module 420 can choose a node in the tree that matches a device characteristic of the device 400. Preferably this is the lowest node in the tree corresponding to a device characteristic of the device 400. The user interface module 420 then determines a shortest path in the tree from the top node to the chosen node, and collects the style information of the nodes on the shortest path, either starting at the top node, or starting at the chosen node.

In the example given above, the user interface module 420 chooses the node 640×480 at level L5, and determines the shortest path from node GNRC to the chosen node. This path passes through nodes GFX (level L2), LNDSCP (level L3) and 4:3 (level L4). The user interface module 420 now knows which style information in the various style sheet documents to access, namely that information associated with those nodes, and can skip information associated with other nodes.

Alternatively, the user interface module 420 might at every level consult the list of device characteristics to select the most promising child element. So the user interface module 420 would then consult the list to determine that a graphical display is available, and then collect the style information from the node GFX. Since the corresponding element GFX in the first style sheet document 211 refers to the second style sheet document 212, this second style sheet document 212 is retrieved and processed. The user interface module 420 now again consults the list and determines that the <landscape> element contains relevant information for the user interface. So, this element is then processed.

The style information collecting functionality of the user interface module 420 could also be provided in the server 101, or in another server. The device 400 may be restricted in its processing capabilities, for example because it is battery-driven or has only limited memory, CPU processing power or available bandwidth. It is then advantageous to collect the style information on a server with higher processing capabilities, so that only the result needs to be transmitted to the device 400. The device 400 then only needs to apply the collected style information to its user interface, which requires much less processing power. In that case, the device 400 could submit its device characteristics profile to the server, so that an appropriately customized style sheet can be generated, or irrelevant style information can be filtered out.

A preferred interpretation of the elements and attributes used in the level L2 style sheet document and the associated DTD is as follows. Note that n denotes a numerical value, str a string value, and url a Uniform Resource Locator (RFC 1738) or Uniform Resource Identifier (RFC 2396).

| Tag | Attributes | Meaning |
|---|---|---|
| <uisl> | xmlns = url | Contains the style attributes of the level indicated by |
| </uisl> | level = n | attribute “level” (in this case 1). The xmlns attribute |
| | | (a standard XML attribute) is used here to define the |
| | | default namespace of the document. |
| <gfx> | none | Contains style attributes for screen based devices |
| </gfx> | | |
| <general> | none | Contains general screen based style attributes, such |
| </general> | | as background colors. |
| <bgcolor> | none | Defines the background color of the user interface |
| </bgcolor> | | elements. This is done by mapping all or certain UI |
| | | elements to a color value. Color values are defined |
| | | using the following syntax: ‘#’ + 2-char hex value |
| | | for red (between 00 to ff) + 2-char hex value for |
| | | green + 2-char hex value for blue, E.g.: #ff00ff for |
| | | purple color. |
| <font> | none | Specifies a hint about which kind of font should be |
| </font> | | used. The possible values are: |
| | | - serif-proportional |
| | | - sansserif-proportional |
| | | - serif-nonproportional |
| | | - sansserif-nonproportional |
| | | Serif fonts are e.g. “Times” and “Garamond” |
| | | Sans-serif fonts are e.g. “Arial” and “Helvetica”. |
| | | All these fonts are proportional. An example of a |
| | | non-proportional font is “Courier”. |
| <portrait> | none | Provides style hints for portrait screens (i.e. when |
| </portrait> | | the top is narrower than the sides in the position |
| | | normally used by people). The style attributes that |
| | | can be defined here are the layout and the orientation |
| | | of the elements. Others are defined in level 2 of the |
| | | UI stylesheet language (referred to by a <level2>-tag |
| | | inside this <portrait>-tag). |
| <landscape> | none | Provides style hints for landscape screens (i.e. when |
| </landscape> | | the top is broader than the sides in the position |
| | | normally used by people). The style attributes, which |
| | | can be defined here, are the layout and the |
| | | orientation of the elements. Others are defined in level 2 of the |
| | | UI stylesheet language (referred to by |
| | | a <level2>-tag inside this <landscape>-tag). |
| <layout> | none | Specifies how the elements should be ordered inside |
| </layout> | | the containers. All layout “algorithms” which can be |
| | | chosen here, start in the upper-left comer of the |
| | | screen and place the elements one by one in vertical |
| | | direction (default) or horizontal if the orientation of |
| | | this container is specified as horizontal (see |
| | | <orientation>-tag). The “algorithms” which can be |
| | | chosen are: |
| | | - panelsplit: place the elements one after another |
| | | including complete subcontainers with their |
| | | elements and if the next element does not fit |
| | | anymore, place it on a new panel, in this way |
| | | splitting the user interface over several panels. It |
| | | is required for a client to provide some means of |
| | | navigation between the different panels if this |
| | | layout algorithm is used. |
| | | - panelgrid: place the elements one by one and |
| | | continue in another column (orientation: |
| | | vertical) or in another row (orientation: |
| | | horizontal) if the next element does not fit |
| | | anymore, forming a grid. A grid means that all |
| | | columns and all rows have the same number of |
| | | grid cells the size of which is determined by the |
| | | biggest element in the row and the column. If no |
| | | more columns (or rows) fit on the screen, the |
| | | client can place them on another panel (i.e. split |
| | | the UI over several panels) or provide a means |
| | | of scrolling. |
| | | - paneltree: place the elements one by one and |
| | | continue in the next column (orientation: |
| | | vertical) or in the next row (orientation: |
| | | horizontal), but independent from the previous |
| | | column/row, i.e. does not have to form a grid, so |
| | | each column can contain a different number of |
| | | UI elements. |
| | | - menusplit: same as panelsplit, but now the |
| | | subcontainers can be hidden. Only the label of |
| | | the subcontainer has to be shown and not all its |
| | | elements, in this way forming a hierarchy of |
| | | menus and submenus. |
| | | - menutree: (the default algorithm for containers) |
| | | same as paneltree, but now the subcontainers |
| | | can be hidden. Only the label of the subcontainer |
| | | has to be shown and not all its elements. |
| <orientation> | none | Specifies the orientation in which UI elements |
| </orientation> | | should be drawn. Can be either: vertical (default for |
| | | containers) or horizontal (default for other UI |
| | | elements). The text labels have to remain readable if the |
| | | orientation is vertical, so not rotated, but written |
| | | top-down, and images never have to be rotated. They |
| | | will always keep their original orientation. |
| <level2/> | stylesheet = | Specifies the stylesheet for the more detailed level 2. |
| | str | A client which does not adhere to the <layout> and |
| | stylesheet- | <orientation> settings, mentioned above, is not |
| | type = str | allowed to use the level 2 style sheet information for |
| | | graphics capabilities. |
| <audio> | none | Contains style attributes for devices which support |
| </audio> | | sound and voice based interaction. |
| <audiogeneral> | none | Contains general sound based style attributes, such |
| </audiogeneral> | | as focus sounds and action sounds |
| <focussound> | none | Specifies for UI elements which sound should be |
| </focussound> | | played when that UI element gets focus. |
| <actionsound> | none | Specifies for UI elements which sound should be |
| </actionsound> | | played when a user action occurs on that UI element. |
| <commandbased> | none | Contains style attributes for devices with command- |
| </commandbased> | | based speech recognition |
| <phonemebased> | none | Contains style attributes for devices with |
| </phonemebased> | | phonemebased speech recognition |

A preferred interpretation of the elements and attributes used in the level L2 style sheet document and the associated DTD is as follows.

| Tag | Attributes | Meaning |
|---|---|---|
| <uisl> | xmlns = url | Contains the style attributes of the level indicated by |
| </uisl> | level = n | attribute “level” (in this case 1). The xmlns attribute |
| | | (a standard XML attribute) can be used here to define |
| | | the default namespace of the document. |
| <4x3> | none | Contains style attributes for screens with a 4x3 |
| </4x3> | | aspect ratio. |
| <16x9> | none | Contains style attributes for screens with a 16x9 |
| </16x9> | | aspect ratio |
| <otherratio> | longside = n | Defines the style attributes for screens with an |
| </otherratio> | shortside = n | alternative ratio, where the longest side is indicated |
| | | by attribute “longside” and the shortest side is |
| | | indicated by attribute “shortside” |
| <minwidth> | none | Specifies the minimum width of a container as a |
| </minwidth> | | percentage of the screen estate occupied by its parent |
| | | container (i.e. the screen in case of the root |
| | | container). The container in focus may not be drawn |
| | | smaller than this size. |
| <minheight> | none | Specifies the minimum height of a container as a |
| </minheight> | | percentage of the screen estate occupied by its parent |
| | | container (i.e. the screen in case of the root |
| | | container). The container in focus may not be drawn |
| | | smaller than this size. |
| <maxwidth> | none | Specifies the maximum width of a container as a |
| </maxwidth> | | percentage of the screen estate occupied by its parent |
| | | container (i.e. the screen in case of the root |
| | | container). The container in focus may not be drawn |
| | | bigger than this size. |
| <maxheight> | none | Specifies the maximum height of a container as a |
| </maxheight> | | percentage of the screen estate occupied by its parent |
| | | container (i.e. the screen in case of the root |
| | | container). The container in focus may not be drawn |
| | | bigger than this size. |
| <halign> | none | Specifies the horizontal alignment of the element in |
| </halign> | | its column. The possible values are “left”, “center” |
| | | or “right”. In case of a horizontally oriented panel- |
| | | or menutree or a horizontally oriented panel/menu- |
| | | split, this value can be ignored. |
| <valign> | none | Specifies the vertical alignment of the element in its |
| </valign> | | row. The possible values are “top”, “center” or |
| | | “bottom”. In case of a vertically oriented panel- or |
| | | menutree or a vertically oriented panel/menu-split, |
| | | this value can be ignored. |
| <alwaysvisible> | none | Specifies that an element should always be visible in |
| </alwaysvisible> | | the user interface (value: “true”) or that it is not so |
| | | important and can be left out (value: “false”). The |
| | | default value is “true”. |
| <alwaystogether> | none | Specifies that the elements within the referenced |
| </alwaystogether> | | containers always have to be grouped together (i.e. |
| | | shown together when the container has focus) and |
| | | must not be split over different unrelated containers. |
| | | If the elements don't fit together on the screen, some |
| | | mechanism has to be provided which makes all |
| | | elements accessible without having to navigate to |
| | | another container/screen, for example using |
| | | scrolling. |
| | | The containers which are defined to be |
| | | alwaystogether should ignore panel- and menu-split |
| | | values specified for <layout> (in level 1) |
| <level3/> | stylesheet = | Specifies the stylesheet for the more detailed level 3. |
| | str | A client which did not adhere to the settings, |
| | stylesheet- | mentioned above, is not allowed to use the level 3 |
| | type = str | style sheet information. |

It should be noted that the above-mentioned embodiments illustrate rather than limit the invention, and that those skilled in the art will be able to design many alternative embodiments without departing from the scope of the appended claims.

For example, it is not necessary that style information at one level L1, L2, L3, . . . is stored in separate style sheet documents, although doing so makes reuse of style information easier. XML elements other than the ones given above could be provided, or attributes could be added or removed as desired. Links to further, more specific style sheet documents could also be provided outside the context of specific elements, for example using the @import or @media constructs as available in CSS.

Two nodes at the same level may correspond, in whole or in part, to the same device characteristic. For example, one node could correspond to 640-pixel wide screens, and, another to 480-pixel high screens. A device with a 640×480 screen now has the option to pick either of these two nodes, or both. The decision to pick one may be arbitrary or based on a determination of what is most important in this device (e.g. screen width is fixed, but scroll bars can be used for insufficient screen height).

This may even cause the hierarchical tree to resemble an acyclic directed graph with a single root. This makes the invention more flexible, but it is slightly more difficult to purse such a tree.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of styling a user interface for a device, comprising obtaining style information for the user interface, the style information being associated with nodes in a hierarchical tree, each node in the tree corresponding to a device characteristic, whereby a child node corresponds to a more specific device characteristic than its parent node, choosing a node in the hierarchical tree, collecting style information for the chosen node and all parents of the chosen node, and applying the collected style information to the user interface.

2. The method of claim 1, wherein the chosen node corresponds to a device characteristic that matches the device.

3. The method of claim 2, wherein the chosen node is the lowest node in the tree corresponding to a device characteristic that matches the device.

4. The method of claim 1, wherein style information at a first level of the tree is made available in a first style sheet document, style information at a second level of the tree, lower than the first level, is made available in a second style sheet document, and a link is provided in the first style sheet document to the second style sheet document.

5. The method of claim 4, wherein the link to the second style sheet document is provided through a link element within the scope of a language element representing a parent of a node associated with style information in the second style sheet document.

6. The method of claim 1, further comprising determining a shortest path in the tree from the top node to the chosen node, and collecting the style information associated with the nodes on the shortest path.

7. The method of claim 6, further comprising collecting the style information starting with the top node.

8. The method of claim 1, further comprising transmitting the collected style information to the device before applying the collected style information to the user interface.

9. A device having an adaptive user interface, comprising means for obtaining style information for the user interface, the style information being associated with nodes in a hierarchical tree, each node in the tree corresponding to a device characteristic, whereby a child node corresponds to a more specific device characteristic than its parent node, and user interface means for choosing a node in the hierarchical tree, collecting style information for the chosen node and all parents of the chosen node, and applying the collected style information to the user interface.

10. A computer program product comprising means for obtaining style information for a user interface for a device, the style information being associated with nodes in a hierarchical tree, each node in the tree corresponding to a device characteristic, whereby a child node corresponds to a more specific device characteristic than its parent node, and user interface means for choosing a node in the hierarchical tree, collecting style information for the chosen node and all parents of the chosen node, and applying the collected style information to the user interface.
